(19) United States
(12) Patent Application Publication
(10) Pub. No.: US 2026/0032287 A1
(43) Pub. Date: Jan. 29, 2026

(54) CROSS-COMPONENT AND CROSS-ATTRIBUTE PREDICTION FOR REGION-ADAPTIVE HIERARCHICAL TRANSFORM IN POINT CLOUD CODING

(71) Applicants: Douyin Vision Co., Ltd., Beijing (CN); Bytedance Inc., Los Angeles, CA (US)

(72) Inventors: Bharath Vishwanath, San Diego, CA (US); Yingzhan Xu, Beijing (CN); Wenyi Wang, Beijing (CN); Kai Zhang, San Diego, CA (US); Li Zhang, San Diego, CA (US)

(21) Appl. No.: 19/351,113

(22) Filed: Oct. 6, 2025

Related U.S. Application Data
(63) Continuation of application No. PCT/CN2024/085865, filed on Apr. 3, 2024.

(30) Foreign Application Priority Data
Apr. 8, 2023 (WO) PCT/CN2023/087181

(51) Int. Cl. H04N 19/61; H04N 19/119; H04N 19/176; H04N 19/30; H04N 19/597; H04N 19/70

(52) U.S. Cl. CPC H04N 19/61; H04N 19/119; H04N 19/176; H04N 19/30; H04N 19/597; H04N 19/70

(57) ABSTRACT

A mechanism for processing video data is disclosed. The mechanism can include determining a first signal (Y) attribute can be predicted from a second signal (X) attribute. A conversion can then be performed between a visual media data and a bitstream based on the Y attribute and the X attribute.

### CROSS-REFERENCE TO RELATED APPLICATIONS

This is a continuation of International Patent Application No. PCT/CN2024/085865, filed on Apr. 3, 2024, which claims the priority to and benefits of International Patent Application No. PCT/CN2023/087181, filed on Apr. 8, 2023. All the aforementioned patent applications are hereby incorporated by reference in their entireties.

### TECHNICAL FIELD

The present disclosure relates to generation, storage, and consumption of digital audio video media information in a file format.

### BACKGROUND

Digital video accounts for the largest bandwidth used on the Internet and other digital communication networks. As the number of connected user devices capable of receiving and displaying video increases, the bandwidth demand for digital video usage is likely to continue to grow.

### SUMMARY

A first aspect relates to a method for processing video data comprising: determining a first signal (Y) attribute can be predicted from a second signal (X) attribute; and performing a conversion between a visual media data and a bitstream based on the Y attribute and the X attribute.

A second aspect relates to an apparatus for processing video data comprising: a processor; and a non-transitory memory with instructions thereon, wherein the instructions upon execution by the processor, cause the processor to perform any of the preceding aspects.

A third aspect relates to non-transitory computer readable medium comprising a computer program product for use by a video coding device, the computer program product comprising computer executable instructions stored on the non-transitory computer readable medium such that when executed by a processor cause the video coding device to perform the method of any of the preceding aspects.

A fourth aspect relates to a non-transitory computer-readable recording medium storing a bitstream of a video which is generated by a method performed by a video processing apparatus, wherein the method comprises: determining a first signal (Y) attribute can be predicted from a second signal (X) attribute; and generating a bitstream based on the determining.

A fifth aspect relates to a method for storing bitstream of a video comprising: determining a first signal (Y) attribute can be predicted from a second signal (X) attribute; generating a bitstream based on the determining; and storing the bitstream in a non-transitory computer-readable recording medium.

A sixth aspect relates to a method, apparatus or system described in the present disclosure.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an example of parent-level nodes for each sub-node of transform unit node.

FIG. 2 is a block diagram showing an example video processing system.

FIG. 3 is a block diagram of an example video processing apparatus.

FIG. 4 is a flowchart for an example method of video processing.

FIG. 5 is a block diagram that illustrates an example video coding system.

FIG. 6 is a block diagram that illustrates an example encoder.

FIG. 7 is a block diagram that illustrates an example decoder.

FIG. 8 is a schematic diagram of an example encoder.

### DETAILED DESCRIPTION

It should be understood at the outset that although an illustrative implementation of one or more embodiments are provided below, the disclosed systems and/or methods may be implemented using any number of techniques, whether currently known or yet to be developed. The disclosure should in no way be limited to the illustrative implementations, drawings, and embodiments illustrated below, including the exemplary designs and implementations illustrated and described herein, but may be modified within the scope of the appended claims along with their full scope of equivalents.

### 1. Initial Discussion

This disclosure is related to media file format. Specifically, this disclosure is related to point cloud coding technologies. Specifically, it is related to cross-component and cross-attribute prediction in region-adaptive hierarchical transform. The disclosed embodiments may be applied individually or in various combination, to any point cloud coding standard or non-standard point cloud codec, e.g., the being-developed Geometry based Point Cloud Compression (G-PCC).

### 2. Abbreviations

The following abbreviations may be used throughout this disclosure: Geometry based Point Cloud Compression (G-PCC), Moving Picture Experts Group (MPEG), Three-dimensional (3D) Graphics Coding Group (3DG), Call For Proposal (CFP), Video-based Point Cloud Compression (V-PCC), Region-Adaptive Hierarchical Transform (RAHT), Sequence Parameter Set (SPS), Attribute Parameter Set (APS), Geometry Parameter Set (GPS).

### 3. Further Discussion

MPEG is one of the main standardization groups dealing with multimedia. In 2017, the MPEG 3DG published a CFP document to start to develop point cloud coding standard[1]. The final standard will consist in two classes of solutions. V-PCC is appropriate for point sets with a relatively uniform distribution of points[2]. G-PCC is appropriate for more sparse distributions[3]. Both V-PCC and G-PCC support the coding and decoding for single point cloud and point cloud sequence.

In one point cloud, there may be geometry information and attribute information. Geometry information is used to describe the geometry locations of the data points. Attribute information is used to record some details of the data points, such as textures, normal vectors, reflections and so on.

### 3.1 Octree Geometry Compression

Point cloud codec can process the various information in different ways. Usually there are many optional tools in the codec to support the coding and decoding of geometry information and attribute information respectively. Among geometry coding tools in G-PCC, octree geometry compression has an important influence for point cloud geometry coding performance[4].

In G-PCC, one important point cloud geometry coding tool is octree geometry compression, which leverages point cloud geometry spatial correlation. If geometry coding tools are enabled, a cubical axis-aligned bounding box, associated with octree root node, will be determined according to point cloud geometry information. Then, the bounding box will be subdivided into 8 sub-cubes, which are associated with 8 sub-nodes of root node (a cube is equivalent to node hereafter). An 8-bit code is then generated by specific order to indicate whether the 8 sub-nodes contain points separately, where one bit is associated with one sub-node. The bit associated with one sub-node is referred to as an occupancy bit, and the generated 8-bit code is referred to as an occupancy code. The generated occupancy code will be signaled according to the occupancy information of neighbor node. Then, only the nodes which contain points will be further subdivided into 8 sub-nodes. The process will be performed recursively until the node size is 1. In this way, the point cloud geometry information is converted into occupancy code sequences.

At the decoder side, occupancy code sequences will be decoded, and the point cloud geometry information can be reconstructed according to the occupancy code sequences.

A breadth-first scanning order will be used for the octree. In one level of the octree, the octree node will be scanned in a Morton order. If the coordinate of one node is represented by N bits, the coordinate (X, Y, Z) of the node can be represented as follows:

$$X = ( {x}_{N - 1} {x}_{N - 2} … {x}_{1} {x}_{0} )$$

$$Y = ( {y}_{N - 1} {y}_{N - 2} … {y}_{1} {y}_{0} )$$

$$Z = ( {z}_{N - 1} {z}_{N - 2} … {z}_{1} {z}_{0} )$$

Its Morton code can be represented as follows:

$$M = ( {x}_{N - 1} {y}_{N - 1} {z}_{N - 1} {x}_{N - 2} {y}_{N - 2} {z}_{N - 2} … {x}_{1} {y}_{1} {z}_{1} {x}_{0} {y}_{0} {z}_{0} )$$

The Morton order is the order from small to large according to Morton code.

### 3.2 Region-Adaptive Hierarchical Transform

In G-PCC, one important point cloud attribute coding tool is RAHT. RAHT is a transform that uses the attributes associated with a node in a lower level of the octree to predict the attributes of the nodes in the next level[5]. RAHT assumes that the positions of the points are given at both the encoder and decoder. RAHT follows the octree scan backwards, from leaf nodes to root node, at each step recombining nodes into larger ones until reaching the root node. At each level of octree, the nodes are processed in the Morton order. At each decomposition, instead of grouping eight nodes at a time, RAHT does it in three steps along each dimension, (e.g., along z, then y then x). If there are L levels in octree, RAHT takes 3L levels to traverse the tree backwards.

Let the nodes at level l be g_{l,x,y,z}, for x, y, z integers. g_{l,x,y,z} was obtained by grouping g_{l+1,2x,y,z} and g_{l+1,2x+1,y,z}, where the grouping along the first dimension was an example. RAHT only process occupied nodes. If one of the nodes in the pair is unoccupied, the other one is promoted to the next level, unprocessed, i.e., g_{l-1,x,y,z}=g_{1,2x,y,z} if the latter is the occupied node of the pair. The grouping process is repeated until reaching the root node. Note that the grouping process generates nodes at lower levels that are the result of grouping different numbers of voxels along the way. The number of nodes grouped to generate node g_{l,x,y,z} is the weight ω_{l,x,y,z} of that node.

At every grouping of two nodes, such as g_{l,2x,y,z} and g_{l,2x+1,y,z}, with their respective weights, ω_{l,2x,y,z} and ω_{l,2x+1,y,z}, RAHT applies the following transform:

$$[ \begin{matrix}{g}_{l - 1 , x , y , z} \\ {h}_{l - 1 , x , y , z}\end{matrix} ] = {T}_{{ω}_{1} {ω}_{2}} [ \begin{matrix}{g}_{l , 2 x , y , z} \\ {h}_{l , 2 x + 1 , y , z}\end{matrix} ] ,$$

Where ω₁=ω_{l,2xy,z} and ω₂=ω_{l,2x+1,y,z} and

$${T}_{{ω}_{1} {ω}_{2}} = \frac{1}{\sqrt{{ω}_{1} + {ω}_{2}}} [ \begin{matrix}\sqrt{{ω}_{1}} & \sqrt{{ω}_{2}} \\ - \sqrt{{ω}_{2}} & \sqrt{{ω}_{1}}\end{matrix} ] .$$

Note that the transform matrix changes at all times, adapting to the weights, i.e., adapting to the number of leaf nodes that each g_{l,x,y,z} actually represents. The quantities g_{l,x,y,z} are used to group and compose further nodes at a lower level. h_{l,x,y,z} are the actual high-pass coefficients generated by the transform to be encoded and transmitted. Furthermore, weights accumulate for the level above. In the above example,

$${ω}_{l - 1 , 2 , y , z} = {ω}_{l , 2 x , y , z} + {ω}_{l , 2 x + 1 , y , z}$$

In the last stage, the tree root, the remaining two voxels g_{1,0,0,0} and g_{1,1,0,0} are transformed into the final two coefficients as:

$$[ \begin{matrix}{g}_{DC} \\ {h}_{0 , 0 , 0 , 0}\end{matrix} ] = {T}_{{ω}_{1 , 0 , 0 , 0} {ω}_{1 , 1 , 0 , 0}} [ \begin{matrix}{g}_{1 , 0 , 0 , 0} \\ {g}_{1 , 1 , 0 , 0}\end{matrix} ]$$

Where g_{DC}=g_{0,0,0,0}.

### 3.3 Up-Sampled Transform Domain Prediction in RAHT

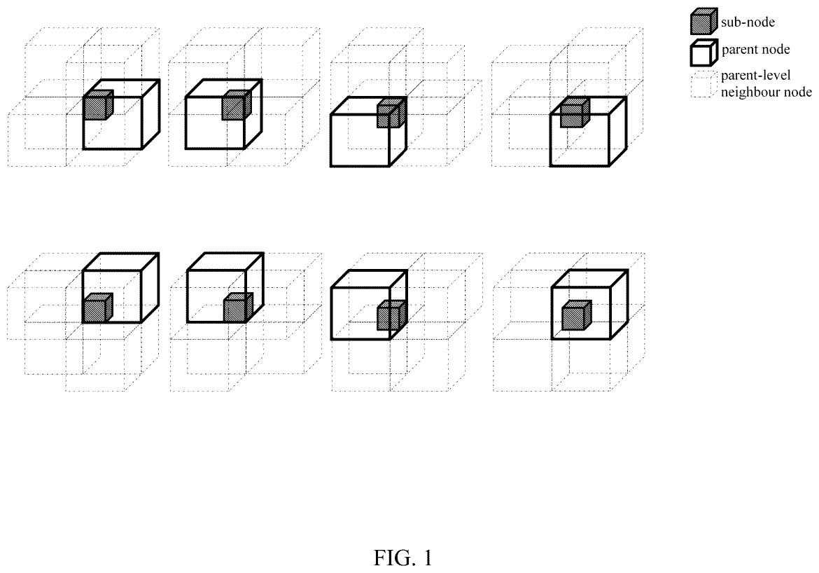

FIG. 1 is an example of parent-level nodes for each sub-node of transform unit node.

The transform domain prediction is introduced to improve coding efficiency on RAHT[6]. It is formed of two parts.

First, the RAHT tree traversal is changed to be descent based from the previous ascent-based approach, i.e., a tree of attribute and weight sums is constructed and then RAHT is performed from the root of the tree to the leaves for both the encoder and the decoder. The transform is also performed in octree node transform unit that has 2×2×2 sub-nodes. Within the node, the encoder transform order is from leaves to the root.

Second, for each sub-node of transform unit, a corresponding predicted sub-node is produced by upsampling the previous transform level. Actually, only sub-node that contains at least one point will produce a corresponding predicted sub-node. The transform unit that contains 2×2×2 predicted sub-nodes is transformed and subtracted from the transformed attributes at the encoder side. The residual of AC coefficients will be signalled. Note that the prediction does not affect the DC coefficient.

Each sub-node of transform unit node is predicted by 7 parent-level nodes where 3 coline parent-level neighbor nodes, 3 coplane parent-level neighbor nodes and 1 parent node. Coplane and coline neighbors are the neighbors that share a face and an edge with current transform unit node, respectively. FIG. 1 shows seven parent-level nodes for each sub-node of transform unit node.

The attribute aᵤₚ of each sub-node is predicted depending on the distance between the sub-node and its parent-level node as follows:

$${a}_{up} = \sum {ω}_{k} {a}_{k} / \sum {ω}_{k}$$

Where aₖ is the attribute of its one parent-level node and Ok is weight depending on the distance. In G-PCC, ωₚₐᵣₑₙₜ:ω_{coplane}:ω_{coline}=4:2:1.

### 3.4 Coding Parameter Classification

There are some coding parameters in the encoder to control the encoding of point cloud. Some of them are signaled to the decoder to support the decoding process. The parameters can be classified and stored in several clusters according to the affected part of each parameter, such as geometry parameter set (GPS), attribute parameter set (APS) and sequence parameter set (SPS). The parameters that control the geometry coding tools are stored in GPS. The parameters that control the attribute coding tools are stored in APS. For example, the parameters that describe the attribute category of point cloud sequence and the data accuracy of coding process are stored in SPS.

### 4. Technical Problems Addressed by Disclosed Embodiments

An example design for region-adaptive hierarchical transform (RAHT) coefficients has the following problems:

First, in the example design, for color attribute compression, each attribute is coded independently, thereby neglecting any cross-attribute correlation.

Second, in the example design, for color attribute compression, each channel is coded independently, thereby neglecting any cross-component correlation.

### 5. A Listing of Solutions and Embodiments

To address at least some of the above problems and some other problems not mentioned, methods as summarized below are disclosed. The items should be considered as examples to explain the general concepts and should not be interpreted in a narrow way. Furthermore, these embodiments can be applied individually or combined in any manner.

In the following discussion, two attribute signals X and Y are utilized as an example, where Y is predicted from X. It should be noted that the solutions could be extended to other cases in which Y is predicted from multiple attribute signals (e.g., in addition to X, or as alternatives to X).
1) In one example, Y may be predicted from X.
   a. In one example, X and/or Y may be two components/channels of an attribute.
   b. In one example, X and/or Y may be from a same attribute.
   c. In one example, X and/or Y may be from different attributes.
   d. In one example, X and/or Y may be from a same sample.
   e. In one example, X and/or Y may be from different samples.
   f. In one example, X and/or Y may be reconstructed values or transformed domain values.
   g. In one example, X and/or Y may be the residue values or transformed residue values.
   h. In one example, a linear or non-linear function may be applied during the prediction from X to Y.
      i. Alternatively, furthermore, the function parameters may be derived on-the-fly or pre-defined or indicated in a bitstream.
   i. In one example, Y may be predicted from X and/or neighbors of X.
      i. Alternatively, furthermore, the neighbors of X may be those in the same layer or different layers.
2) In one example, Y may be predicted from reconstructed X (X_{rec}) and the prediction model may be denoted as:

$${Y}_{pred} = α {X}_{rec} + β$$

where α and β are the model parameters.
3) In one example, the AC component of Y may be predicted from the AC component of reconstructed X (X_{rec}) and the prediction model may be denoted as:

$${Y}_{pred , AC} = α {X}_{rec , AC}$$

where X_{rec,AC} is the signal obtained after removing the DC component from the signal, and α is the model parameter.
4) In one example, Y maybe predicted from X_{rec} of the current sample and the neighboring samples, the prediction model may be denoted as:

$${Y}_{pred} = {α}_{0} {X}_{rec} + {α}_{1} {X}_{rec , 1} + … + {α}_{N} {X}_{rec , N} + β$$

where the X_{rec} of the i^{th} neighbor is denoted as X_{rec,i}, and where α₀, α₁ . . . α_{N} and β are the model parameters.
   a. In one example, the number of neighbors used for prediction may be signalled to the decoder.
   b. In one example, the number of neighbors may be fixed.
   c. In one example, the number of neighbors used may be decided based on distance criteria.
      i. For example, only samples within a certain distance threshold are included in the prediction model.
      ii. In one example, the distance threshold may be fixed.
      iii. In one example, the distance threshold may be signalled to the decoder.
5) In one example, Y may be predicted from X_{rec} with the prediction model with non-linear terms.
   a. For example, the prediction model with squared reconstruction

$${X}_{rec}^{2}$$

as non-linear term may be denoted such as:

$${Y}_{pred} = {α}_{0} {X}_{rec} + {α}_{1} {X}_{rec}^{2} + β$$

Where α₀, α₁ and β are the motion parameters.
   b. In one example, the non-linear terms may be signalled to the decoder.
   c. In one example, a fixed model with non-linear terms may be employed.
6) In one example, at least one model parameter may be signaled to the decoder.
7) In one example, at least one model parameter may be derived at the decoder.
   a. In one example, at least one model parameter may be derived based on samples reconstructed before the current block/sample.
   b. In one example, a least squares estimate (LSE, a.k.a. minimizing mean squared error (MSE)) may be used to derive the parameters.
   c. In one example, an LDL decomposition may be used to derive at least one parameter.
   d. In one example, the reconstruction neighborhood used to derive parameters may be fixed or sent to the decoder.
      i. For example, the samples from the last M reconstructed RAHT nodes may be used for model parameter derivation.
      ii. For example, the samples from the M nearest neighbor reconstructed RAHT nodes may be used for model parameter derivation.
   e. In one example, the reconstruction neighborhood used to derive parameters may depend on the RAHT layer.
      i. For example, lower layers may use more of previously coded or neared neighbor RAHT nodes and higher layers use lesser number of previously coded or nearest neighbor RAHT nodes. That is, M is relatively larger for a lower RAHT layer, and is relatively smaller for a higher RAHT layer.
      ii. For example, the number RAHT nodes used may follow a fixed modulation function such as reduction by a factor as we move up the tree (e.g., in increasing RAHT layer direction).
      iii. For example, the modulation function may be sent to the decoder.
   f. For example, an explicit number may be sent to the decoder per layer.
8) In one example, Y may be predicted from X_{rec} with a polynomial prediction model.
   a. For example,

$${Y}_{pred} = {α}_{0} {X}_{rec} + {α}_{1} {X}_{rec , 1} + … + {α}_{N} {X}_{rec , N} + {α}_{0}^{′} {X}_{rec}^{2} + β$$

9) In one example, multiple models may be used for cross-component prediction.
   a. In one example, whether one model or multiple models are applied may be signaled.
   b. In one example, the number of models may be signaled.
10) In one example, there may be additional flexibility to choose between different prediction models.
   a. In one example, the selection may be derived at the encoder.
   b. In one example, additional flags may be signalled to the decoder to indicate the selection result.
   c. In one example, the selection may be derived at the decoder.
   d. In one example, additional flags may be signalled to the decoder to indicate whether the selection is to be enabled at the decoder.
11) In one example, the model parameters may be determined by encoder and signaled to the decoder.
   a. For example, the encoder may estimate parameters based on least square minimization or other criteria.
      i. The estimated value may be quantized and sent to the decoder.
      ii. The estimation may be per octree layer/region/voxel/block etc.
   b. For example, the encoder may select from the set of pre-determined values.
   c. For example, one parameter may be signaled to the decoder and the other parameter(s) may be derived at the decoder side.
      i. For example, β may be signalled to the decoder and a may be derived at the decoder or vice-versa.
12) In one example, the prediction model(s) may be applied before RAHT coding, and the prediction residual of Y is coded by RAHT.
   a. In one example, the point cloud may be divided into blocks of P×Q×R voxels and the prediction method is selectively enabled or disabled for each block.
      i. In one example, the parameters P, Q, and R may be signalled to the decoder.
      ii. In one example, the parameters P, Q, and R may be fixed.
      iii. In one example, for each block that selects the method, the model parameters may be signalled to the decoder.
      iv. In one example, the model parameters may be inherited from the neighboring voxel(s).
      v. In one example, the model parameters may be predictively coded.
   b. In one example, the point cloud may be divided into blocks of N points and the prediction method is selectively enabled or disabled for each block.
      i. In one example, the parameters N may be signalled to the decoder.
      ii. In one example, the parameters N may be fixed.
      iii. In one example, for each block that selects the method, the model parameters may be signalled to the decoder.
      iv. In one example, the model parameters may be inherited from the neighboring block(s).
      v. In one example, the model parameters may be predictively coded.
      vi. In one example, the point cloud may be reordered based on Morton code before being divided into blocks.
      vii. For example, the entire point cloud may be used as a single block (i.e., a single model for the entire point cloud).
   c. In one example, the point cloud may be divided into regions and the prediction method is selectively enabled or disabled for each region.
      i. For example, the regions may be derived from clustering algorithms.
      ii. In one example, the regions may be determined by the encoder and signalled to the decoder.
      iii. In one example, the regions may be derived at the decoder based on information such as coded geometry information.
      iv. In one example, for each region that selects the method, the model parameters may be signalled to the decoder.
      v. In one example, the model parameters may be inherited from the neighboring region(s).
      vi. In one example, the model parameters may be predictively coded.
13) In one example, the prediction model(s) may be applied during the RAHT coding for predicting RAHT node of Y from the RAHT node of the reconstructed X.
   a. In one example, the prediction model(s) may be applied in the sum of attribute space.
   b. In one example, the prediction model(s) may be applied in the transform domain.
   c. In one example, the prediction model(s) may be enabled for a subset of RAHT levels.
      i. For example, the prediction may be enabled for the first K or last K levels.
      ii. For example, the subset may be a fixed subset.
      iii. For example, the subset may be signalled to the decoder.
   d. In one example, the prediction model parameters may be derived from the neighboring nodes.
      i. For example, the neighboring nodes may be used as training samples to derive the model parameters.
   e. In one example, the prediction model(s) may be applied for a RAHT node only if the neighboring nodes benefit from the prediction model(s).
      i. For example, the prediction cost of neighbors, such as sum of absolute differences (SAD), can be computed for the cases with and without enabling the prediction method. The cost reduction by employing prediction is computed as:

$${Cost}_{reduction} = {Cost}_{pred} - {Cost}_{unpred}$$

The prediction model(s) may be applied for the current node only if Cost_{reduction} is less than a threshold.
ii. For example, with two competing predictions, the cost reduction as above may be computed, and the best prediction mode may be selected.
iii. For example, instead of cost reduction, correlation coefficient may be computed, and the mode may be enabled or selected if the magnitude of correlation coefficient is greater than a threshold.
f. In one example, the method may be enabled or disabled for different RAHT layers/nodes/regions.
   i. For example, the model parameters may be derived from neighbors only for RAHT nodes belonging to some regions.
   ii. For example, flags may be sent in a particular layer/set of layers. Further, all or a subset of the children may borrow/inherit the flags.
g. In one example, the model parameters may be derived and signalled to the decoder conditionally on RAHT/node/region level.
   i. In one example, for each RAHT layer/node/region that selects the method, the model parameters may be signalled to the decoder.
   ii. For example, the model parameters may be predictively coded across RAHT layers/nodes/regions.
14) In one example, the above introduced models may be applied for other attribute prediction methods other than RAHT.
   a. For example, the models may be used in predictive transform attribute coding.
   b. For example, the models may be applied for lossless compression case only.
15) Whether to and/or how to apply a method disclosed above may be signaled from encoder to decoder in a bitstream/frame/tile/slice/octree/etc.
16) Whether to and/or how to apply the disclosed methods above may be dependent on coded information, such as dimensions, color format, color component, slice/picture type.

### 6. References

[1] MPEG 3DG and Requirements, “Call for Proposals for Point Cloud Compression V2”, ISO/IEC JTC1/SC29 WG11 N16763.
[2] ISO/IEC JTC 1/SC 29/WG 07, “Information technology—Coded Representation of Immersive Media—Part 5: Visual Volumetric Video-based Coding (V3C) and Video-based Point Cloud Compression (V-PCC)”, ISO/IEC 23090-5.
[3] ISO/IEC JTC 1/SC 29/WG 11, “Information technology—MPEG-I (Coded Representation of Immersive Media)—Part 9: Geometry-based Point Cloud Compression”, ISO/IEC 23090-9:2020(E).
[4] MPEG 3D Graphics Coding, “G-PCC codec description”, ISO/IEC JTC1/SC29 WG07 N0015.
[5] Ricardo L. De Queiroz and Philip A. Chou, “Compression of 3D Point Clouds Using a Region-Adaptive Hierarchical Transform”, IEEE Transactions on Image Processing.
[6]S. Lasserre, D. Flynn, “On an improvement of RAHT to exploit attribute correlation”, ISO/IEC JTC1/SC29/WG11 M47378.

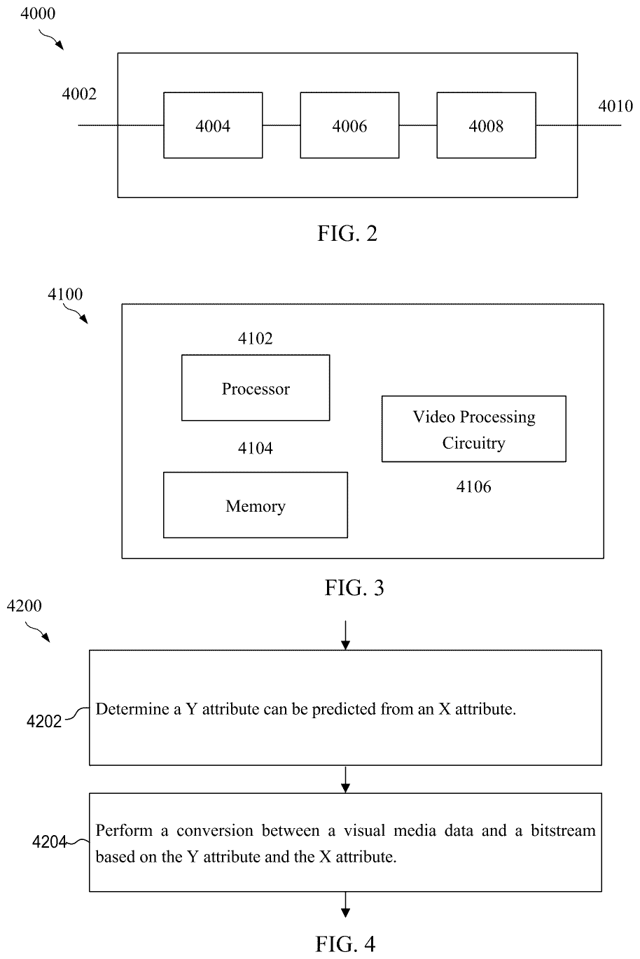

FIG. 2 is a block diagram showing an example video processing system 4000 in which various embodiments disclosed herein may be implemented. Various implementations may include some or all of the components of the system 4000. The system 4000 may include input 4002 for receiving video content. The video content may be received in a raw or uncompressed format, e.g., 8- or 10-bit multi-component pixel values, or may be in a compressed or encoded format. The input 4002 may represent a network interface, a peripheral bus interface, or a storage interface. Examples of network interface include wired interfaces such as Ethernet, passive optical network (PON), etc. and wireless interfaces such as Wi-Fi or cellular interfaces.

The system 4000 may include a coding component 4004 that may implement the various coding or encoding methods described in the present disclosure. The coding component 4004 may reduce the average bitrate of video from the input 4002 to the output of the coding component 4004 to produce a coded representation of the video. The coding techniques are therefore sometimes called video compression or video transcoding techniques. The output of the coding component 4004 may be either stored, or transmitted via a communication connected, as represented by the component 4006. The stored or communicated bitstream (or coded) representation of the video received at the input 4002 may be used by a component 4008 for generating pixel values or displayable video that is sent to a display interface 4010. The process of generating user-viewable video from the bitstream representation is sometimes called video decompression. Furthermore, while certain video processing operations are referred to as “coding” operations or tools, it will be appreciated that the coding tools or operations are used at an encoder and corresponding decoding tools or operations that reverse the results of the coding will be performed by a decoder.

Examples of a peripheral bus interface or a display interface may include universal serial bus (USB) or high definition multimedia interface (HDMI) or DisplayPort, and so on. Examples of storage interfaces include serial advanced technology attachment (SATA), peripheral component interconnect (PCI), integrated drive electronics (IDE) interface, and the like. The embodiments described in the present disclosure may be embodied in various electronic devices such as mobile phones, laptops, smartphones or other devices that are capable of performing digital data processing and/or video display.

FIG. 3 is a block diagram of an example video processing apparatus 4100. The apparatus 4100 may be used to implement one or more of the methods described herein. The apparatus 4100 may be embodied in a smartphone, tablet, computer, Internet of Things (IoT) receiver, and so on. The apparatus 4100 may include one or more processors 4102, one or more memories 4104 and video processing circuitry 4106. The processor(s) 4102 may be configured to implement one or more methods described in the present disclosure. The memory (memories) 4104 may be used for storing data and code used for implementing the methods and embodiments described herein. The video processing circuitry 4106 may be used to implement, in hardware circuitry, some embodiments described in the present disclosure. In some embodiments, the video processing circuitry 4106 may be at least partly included in the processor 4102, e.g., a graphics co-processor.

FIG. 4 is a flowchart for an example method 4200 of video processing. The method 4200 determines a first signal (Y) attribute can be predicted from a second signal (X) attribute at step 4202. A conversion is performed between a visual media data and a bitstream based on the Y attribute and the X attribute at step 4204. The conversion of step 4204 may include encoding at an encoder or decoding at a decoder, depending on the example.

It should be noted that the method 4200 can be implemented in an apparatus for processing video data comprising a processor and a non-transitory memory with instructions thereon, such as video encoder 4400, video decoder 4500, and/or encoder 4600. In such a case, the instructions upon execution by the processor, cause the processor to perform the method 4200. Further, the method 4200 can be performed by a non-transitory computer readable medium comprising a computer program product for use by a video coding device. The computer program product comprises computer executable instructions stored on the non-transitory computer readable medium such that when executed by a processor cause the video coding device to perform the method 4200.

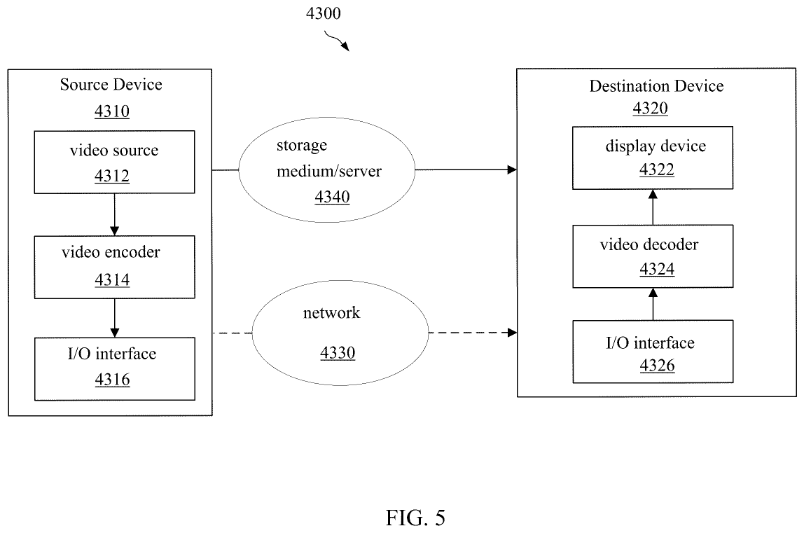

FIG. 5 is a block diagram that illustrates an example video coding system 4300 that may utilize the embodiments of this disclosure. The video coding system 4300 may include a source device 4310 and a destination device 4320. Source device 4310 generates encoded video data which may be referred to as a video encoding device. Destination device 4320 may decode the encoded video data generated by source device 4310 which may be referred to as a video decoding device.

Source device 4310 may include a video source 4312, a video encoder 4314, and an input/output (I/O) interface 4316. Video source 4312 may include a source such as a video capture device, an interface to receive video data from a video content provider, and/or a computer graphics system for generating video data, or a combination of such sources. The video data may comprise one or more pictures. Video encoder 4314 encodes the video data from video source 4312 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. I/O interface 4316 may include a modulator/demodulator (modem) and/or a transmitter. The encoded video data may be transmitted directly to destination device 4320 via I/O interface 4316 through network 4330. The encoded video data may also be stored onto a storage medium/server 4340 for access by destination device 4320.

Destination device 4320 may include an I/O interface 4326, a video decoder 4324, and a display device 4322. I/O interface 4326 may include a receiver and/or a modem. I/O interface 4326 may acquire encoded video data from the source device 4310 or the storage medium/server 4340. Video decoder 4324 may decode the encoded video data. Display device 4322 may display the decoded video data to a user. Display device 4322 may be integrated with the destination device 4320, or may be external to destination device 4320, which can be configured to interface with an external display device.

Video encoder 4314 and video decoder 4324 may operate according to a video compression standard, such as the High Efficiency Video Coding (HEVC) standard, Versatile Video Coding (VVC) standard, and other current and/or further standards.

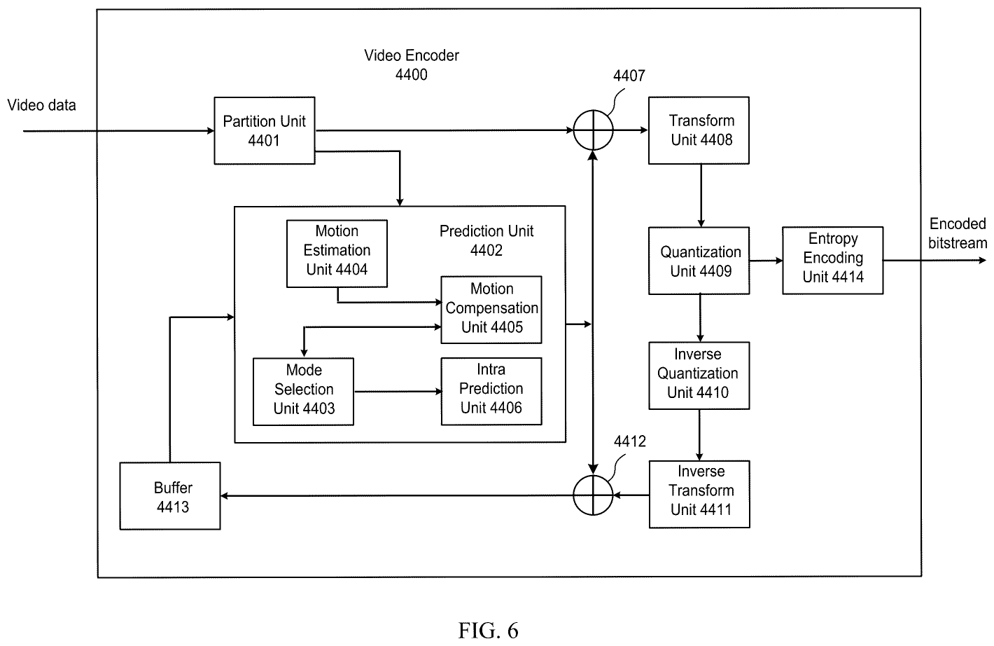

FIG. 6 is a block diagram illustrating an example of video encoder 4400, which may be video encoder 4314 in the system 4300 illustrated in FIG. 5. Video encoder 4400 may be configured to perform any or all of the embodiments of this disclosure. The video encoder 4400 includes a plurality of functional components. The embodiments described in this disclosure may be shared among the various components of video encoder 4400. In some examples, a processor may be configured to perform any or all of the embodiments described in this disclosure.

The functional components of video encoder 4400 may include a partition unit 4401; a prediction unit 4402, which may include a mode select unit 4403, a motion estimation unit 4404, a motion compensation unit 4405, and an intra prediction unit 4406; a residual generation unit 4407; a transform processing unit 4408; a quantization unit 4409; an inverse quantization unit 4410; an inverse transform unit 4411; a reconstruction unit 4412; a buffer 4413; and an entropy encoding unit 4414.

In other examples, video encoder 4400 may include more, fewer, or different functional components. In an example, prediction unit 4402 may include an intra block copy (IBC) unit. The IBC unit may perform prediction in an IBC mode in which at least one reference picture is a picture where the current video block is located.

Furthermore, some components, such as motion estimation unit 4404 and motion compensation unit 4405 may be highly integrated, but are represented in the example of video encoder 4400 separately for purposes of explanation.

Partition unit 4401 may partition a picture into one or more video blocks. Video encoder 4400 and video decoder 4500 may support various video block sizes.

Mode select unit 4403 may select one of the coding modes, intra or inter, e.g., based on error results, and provide the resulting intra or inter coded block to a residual generation unit 4407 to generate residual block data and to a reconstruction unit 4412 to reconstruct the encoded block for use as a reference picture. In some examples, mode select unit 4403 may select a combination of intra and inter prediction (CIIP) mode in which the prediction is based on an inter prediction signal and an intra prediction signal. Mode select unit 4403 may also select a resolution for a motion vector (e.g., a sub-pixel or integer pixel precision) for the block in the case of inter prediction.

To perform inter prediction on a current video block, motion estimation unit 4404 may generate motion information for the current video block by comparing one or more reference frames from buffer 4413 to the current video block. Motion compensation unit 4405 may determine a predicted video block for the current video block based on the motion information and decoded samples of pictures from buffer 4413 other than the picture associated with the current video block.

Motion estimation unit 4404 and motion compensation unit 4405 may perform different operations for a current video block, for example, depending on whether the current video block is in an I slice, a P slice, or a B slice.

In some examples, motion estimation unit 4404 may perform uni-directional prediction for the current video block, and motion estimation unit 4404 may search reference pictures of list 0 or list 1 for a reference video block for the current video block. Motion estimation unit 4404 may then generate a reference index that indicates the reference picture in list 0 or list 1 that contains the reference video block and a motion vector that indicates a spatial displacement between the current video block and the reference video block. Motion estimation unit 4404 may output the reference index, a prediction direction indicator, and the motion vector as the motion information of the current video block. Motion compensation unit 4405 may generate the predicted video block of the current block based on the reference video block indicated by the motion information of the current video block.

In other examples, motion estimation unit 4404 may perform bi-directional prediction for the current video block, motion estimation unit 4404 may search the reference pictures in list 0 for a reference video block for the current video block and may also search the reference pictures in list 1 for another reference video block for the current video block. Motion estimation unit 4404 may then generate reference indexes that indicate the reference pictures in list 0 and list 1 containing the reference video blocks and motion vectors that indicate spatial displacements between the reference video blocks and the current video block. Motion estimation unit 4404 may output the reference indexes and the motion vectors of the current video block as the motion information of the current video block. Motion compensation unit 4405 may generate the predicted video block of the current video block based on the reference video blocks indicated by the motion information of the current video block.

In some examples, motion estimation unit 4404 may output a full set of motion information for decoding processing of a decoder. In some examples, motion estimation unit 4404 may not output a full set of motion information for the current video. Rather, motion estimation unit 4404 may signal the motion information of the current video block with reference to the motion information of another video block. For example, motion estimation unit 4404 may determine that the motion information of the current video block is sufficiently similar to the motion information of a neighboring video block.

In one example, motion estimation unit 4404 may indicate, in a syntax structure associated with the current video block, a value that indicates to the video decoder 4500 that the current video block has the same motion information as another video block.

In another example, motion estimation unit 4404 may identify, in a syntax structure associated with the current video block, another video block and a motion vector difference (MVD). The motion vector difference indicates a difference between the motion vector of the current video block and the motion vector of the indicated video block. The video decoder 4500 may use the motion vector of the indicated video block and the motion vector difference to determine the motion vector of the current video block.

As discussed above, video encoder 4400 may predictively signal the motion vector. Two examples of predictive signaling techniques that may be implemented by video encoder 4400 include advanced motion vector prediction (AMVP) and merge mode signaling.

Intra prediction unit 4406 may perform intra prediction on the current video block. When intra prediction unit 4406 performs intra prediction on the current video block, intra prediction unit 4406 may generate prediction data for the current video block based on decoded samples of other video blocks in the same picture. The prediction data for the current video block may include a predicted video block and various syntax elements.

Residual generation unit 4407 may generate residual data for the current video block by subtracting the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and residual generation unit 4407 may not perform the subtracting operation.

Transform processing unit 4408 may generate one or more transform coefficient video blocks for the current video block by applying one or more transforms to a residual video block associated with the current video block.

After transform processing unit 4408 generates a transform coefficient video block associated with the current video block, quantization unit 4409 may quantize the transform coefficient video block associated with the current video block based on one or more quantization parameter (QP) values associated with the current video block.

Inverse quantization unit 4410 and inverse transform unit 4411 may apply inverse quantization and inverse transforms to the transform coefficient video block, respectively, to reconstruct a residual video block from the transform coefficient video block. Reconstruction unit 4412 may add the reconstructed residual video block to corresponding samples from one or more predicted video blocks generated by the prediction unit 4402 to produce a reconstructed video block associated with the current block for storage in the buffer 4413.

After reconstruction unit 4412 reconstructs the video block, the loop filtering operation may be performed to reduce video blocking artifacts in the video block.

Entropy encoding unit 4414 may receive data from other functional components of the video encoder 4400. When entropy encoding unit 4414 receives the data, entropy encoding unit 4414 may perform one or more entropy encoding operations to generate entropy encoded data and output a bitstream that includes the entropy encoded data.

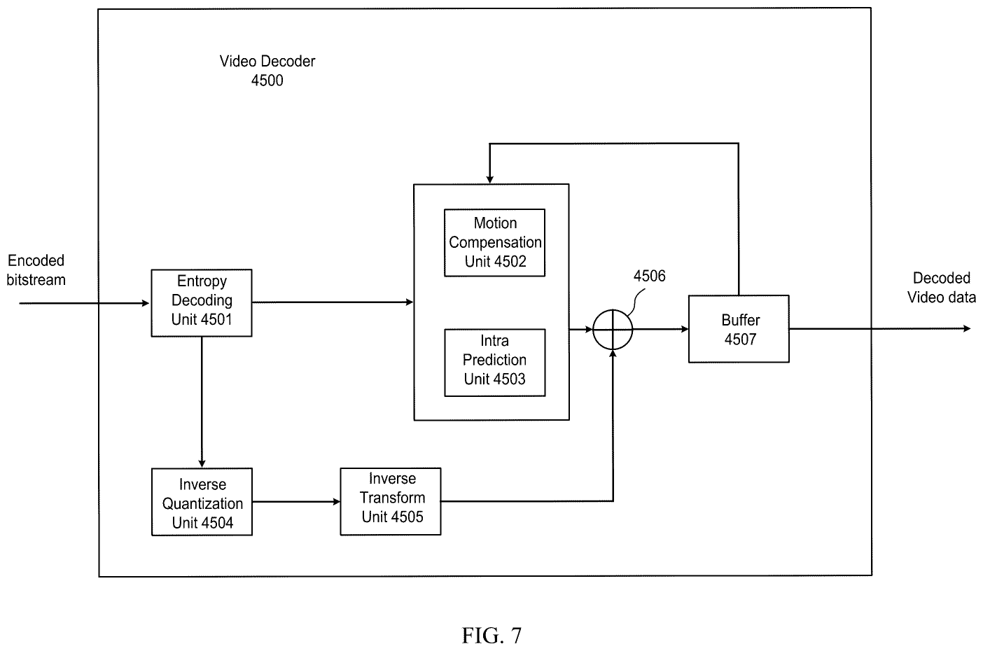

FIG. 7 is a block diagram illustrating an example of video decoder 4500 which may be video decoder 4324 in the system 4300 illustrated in FIG. 5. The video decoder 4500 may be configured to perform any or all of the embodiments of this disclosure. In the example shown, the video decoder 4500 includes a plurality of functional components. The embodiments described in this disclosure may be shared among the various components of the video decoder 4500. In some examples, a processor may be configured to perform any or all of the embodiments described in this disclosure.

In the example shown, video decoder 4500 includes an entropy decoding unit 4501, a motion compensation unit 4502, an intra prediction unit 4503, an inverse quantization unit 4504, an inverse transformation unit 4505, a reconstruction unit 4506, and a buffer 4507. Video decoder 4500 may, in some examples, perform a decoding pass generally reciprocal to the encoding pass described with respect to video encoder 4400.

Entropy decoding unit 4501 may retrieve an encoded bitstream. The encoded bitstream may include entropy coded video data (e.g., encoded blocks of video data). Entropy decoding unit 4501 may decode the entropy coded video data, and from the entropy decoded video data, motion compensation unit 4502 may determine motion information including motion vectors, motion vector precision, reference picture list indexes, and other motion information. Motion compensation unit 4502 may, for example, determine such information by performing the AMVP and merge mode.

Motion compensation unit 4502 may produce motion compensated blocks, possibly performing interpolation based on interpolation filters. Identifiers for interpolation filters to be used with sub-pixel precision may be included in the syntax elements.

Motion compensation unit 4502 may use interpolation filters as used by video encoder 4400 during encoding of the video block to calculate interpolated values for sub-integer pixels of a reference block. Motion compensation unit 4502 may determine the interpolation filters used by video encoder 4400 according to received syntax information and use the interpolation filters to produce predictive blocks.

Motion compensation unit 4502 may use some of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter coded block, and other information to decode the encoded video sequence.

Intra prediction unit 4503 may use intra prediction modes for example received in the bitstream to form a prediction block from spatially adjacent blocks. Inverse quantization unit 4504 inverse quantizes, i.e., de-quantizes, the quantized video block coefficients provided in the bitstream and decoded by entropy decoding unit 4501. Inverse transform unit 4505 applies an inverse transform.

Reconstruction unit 4506 may sum the residual blocks with the corresponding prediction blocks generated by motion compensation unit 4502 or intra prediction unit 4503 to form decoded blocks. If desired, a deblocking filter may also be applied to filter the decoded blocks in order to remove blockiness artifacts. The decoded video blocks are then stored in buffer 4507, which provides reference blocks for subsequent motion compensation/intra prediction and also produces decoded video for presentation on a display device.

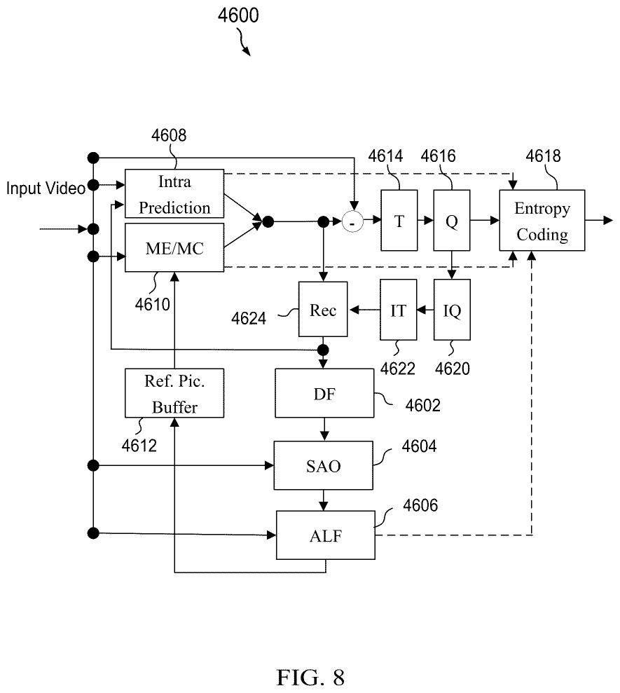

FIG. 8 is a schematic diagram of an example encoder 4600. The encoder 4600 is suitable for implementing the techniques of VVC. The encoder 4600 includes three in-loop filters, namely a deblocking filter (DF) 4602, a sample adaptive offset (SAO) 4604, and an adaptive loop filter (ALF) 4606. Unlike the DF 4602, which uses predefined filters, the SAO 4604 and the ALF 4606 utilize the original samples of the current picture to reduce the mean square errors between the original samples and the reconstructed samples by adding an offset and by applying a finite impulse response (FIR) filter, respectively, with coded side information signaling the offsets and filter coefficients. The ALF 4606 is located at the last processing stage of each picture and can be regarded as a tool trying to catch and fix artifacts created by the previous stages.

The encoder 4600 further includes an intra prediction component 4608 and a motion estimation/compensation (ME/MC) component 4610 configured to receive input video. The intra prediction component 4608 is configured to perform intra prediction, while the ME/MC component 4610 is configured to utilize reference pictures obtained from a reference picture buffer 4612 to perform inter prediction. Residual blocks from inter prediction or intra prediction are fed into a transform (T) component 4614 and a quantization (Q) component 4616 to generate quantized residual transform coefficients, which are fed into an entropy coding component 4618. The entropy coding component 4618 entropy codes the prediction results and the quantized transform coefficients and transmits the same toward a video decoder (not shown). Quantization components output from the quantization component 4616 may be fed into an inverse quantization (IQ) components 4620, an inverse transform component 4622, and a reconstruction (REC) component 4624. The REC component 4624 is able to output images to the DF 4602, the SAO 4604, and the ALF 4606 for filtering prior to those images being stored in the reference picture buffer 4612.

A listing of solutions preferred by some examples is provided next.
1. A method for processing media data comprising: determining a first signal (Y) attribute can be predicted from a second signal (X) attribute; and performing a conversion between a visual media data and a bitstream based on the Y attribute and the X attribute.
2. The method of solution 1, wherein the Y attribute and the X attribute are from: different components, a same attribute, different attributes, a same sample, different samples, reconstructed values, transformed domain values, or combinations thereof.
3. The method of any of solutions 1-2, wherein a linear function or a non-linear function is applied during prediction of Y attribute from the X attribute, and wherein function parameters are derived, pre-defined, or included in the bitstream.
4. The method of any of solutions 1-3, wherein the Y attribute is predicted from neighbors of the X attribute in a same or different layer.
5. The method of any of solutions 1-4, wherein the Y attribute (Ypred) is predicted from reconstructed X (Xrec) and a prediction model is denoted as: Y_{pred}=αX_{rec}+β where α and β are the model parameters.
6. The method of any of solutions 1-5, wherein an alternating current (AC) component of the Y attribute is predicted from an AC component of X (Xrec) and a prediction model is denoted as: Y_{pred,AC}=αX_{rec,Ac} where X_{rec,AC} is a signal obtained after removing a direct current (DC) component from the signal and α is a model parameter.
7. The method of any of solutions 1-6, wherein the Y attribute is predicted from X_{rec} of a current sample and of neighboring samples and the prediction model is denoted as: Y_{pred}=α₀ X_{rec}+α₁X_{rec,1}+ . . . +α_{N}X_{rec,N}+β where the X_{rec} of the ith neighbor is denoted as X_{rec,i} and α₀, α₁ . . . α_{N} and β are model parameters.
8. The method of any of solutions 1-7, wherein a number of neighbors is signaled, fixed, or determined based on distance criteria, the distance criteria including a distance threshold that is fixed, signaled, or included a prediction model.
9. The method of any of solutions 1-8, wherein Y is predicted from X_{rec} with a prediction model with non-linear terms, and wherein the prediction model with squared reconstruction

$${X}_{rec}^{2}$$

as non-linear term is denoted as:

$${Y}_{pred} = {α}_{0} {X}_{rec} + {α}_{1} {X}_{rec}^{2} + β$$

where α₀, α₁ and β are motion parameters.
10. The method of any of solutions 1-9, wherein non-linear terms are signalled or a fixed model with non-linear terms is employed.
11. The method of any of solutions 1-10, wherein at least one model parameter is signaled in the bitstream.
12. The method of any of solutions 1-11, wherein at least one model parameter is derived: based on samples reconstructed before a current block or sample, based on a least square estimate, or based on LDL decomposition.
13. The method of any of solutions 1-12, wherein Y is predicted from X_{rec} with a polynomial prediction model denoted as:

$${Y}_{pred} = {α}_{0} {X}_{rec} + {α}_{1} {X}_{rec , 1} + … + {α}_{N} {X}_{rec , N} + {α}_{0}^{′} {X}_{rec}^{2} + β .$$

14. The method of any of solutions 1-13, wherein multiple models are used for cross-component prediction, and wherein one or more models or a number of the models is signaled.
15. The method of any of solutions 1-14, wherein prediction models are selected according to a derivation or signaled.
16. The method of any of solutions 1-15, wherein model parameters are signaled, and wherein the model parameters are estimated based on least square minimization, selected from a set of predetermined values, or partially signaled and partially derived based on signaling.
17. The method of any of solutions 1-16, wherein a prediction model is applied before Region-Adaptive Hierarchical Transform (RAHT) coding, and a prediction residual of Y is coded by RAHT coding.
18. The method of any of solutions 1-17, wherein a point cloud is divided into blocks of P×Q×R voxels, wherein prediction is selectively enabled or disabled for each block, and wherein P, Q, and R are signaled or fixed, model parameters are signaled for selected blocks, model parameters are inherited from the neighboring voxels, or model parameters are predictively coded.
19. The method of any of solutions 1-18, wherein a point cloud is divided into blocks of N points and prediction is selectively enabled or disabled for each block, and wherein parameters N are signaled or fixed, model parameters are signaled for selected blocks, model parameters are inherited from the neighboring blocks, model parameters are predictively coded, the point cloud is reordered based on Morton code, or an entire point cloud is used as a single block.
20. The method of any of solutions 1-19, wherein the point cloud is divided into regions and prediction is selectively enabled or disabled for each region, and wherein the regions are derived from clustering algorithms, the regions are signaled, the regions are derived based on coded geometry information, model parameters are selectively signaled, model parameters are inherited from the neighboring regions, or model parameters are predictively coded.
21. The method of any of solutions 1-20, wherein a prediction model is applied during RAHT coding for predicting a RAHT node of Y from a RAHT node of the reconstructed X.
22. The method of any of solutions 1-21, wherein the prediction model is applied in a sum of attribute space, applied in a transform domain, or enabled for a subset of RAHT levels, where a prediction is enabled for a first K or last K levels, a subset is a fixed subset, or the subset is signaled.
23. The method of any of solutions 1-22, wherein prediction model parameters are derived from the neighboring nodes, and wherein neighboring nodes are used as training samples to derive the model parameters.
24. The method of any of solutions 1-23, wherein a prediction model is applied for a RAHT node only when neighboring nodes benefit from a prediction model, and wherein a prediction cost of neighbors is computed for cases with and without enabling prediction, wherein a cost reduction by employing prediction is denoted as: Cost_{reduction}=Cost_{pred}−Cost_{unpred}, and wherein the prediction model is applied for a current node only if Cost_{reduction} is less than a threshold.
25. The method of any of solutions 1-24, wherein the prediction model is enabled or disabled for different RAHT layers, nodes, or regions, and wherein model parameters are derived from neighbors only for RAHT nodes included in some regions.
26. The method of any of solutions 1-25, wherein model parameters are derived and signaled conditionally on RAHT, node, or region level or model parameters are predictively coded across RAHT layers, nodes, or regions.
27. The method of any of solutions 1-26, wherein models are used in predictive transform attribute coding or are applied only for lossless compression.
28. An apparatus for processing video data comprising: a processor; and a non-transitory memory with instructions thereon, wherein the instructions upon execution by the processor, cause the processor to perform the method of any of solutions 1-27.
29. A non-transitory computer readable medium comprising a computer program product for use by a video coding device, the computer program product comprising computer executable instructions stored on the non-transitory computer readable medium such that when executed by a processor cause the video coding device to perform the method of any of solutions 1-27.
30. A non-transitory computer-readable recording medium storing a bitstream of a video which is generated by a method performed by a video processing apparatus, wherein the method comprises: determining a first signal (Y) attribute can be predicted from a second signal (X) attribute; and generating a bitstream based on the determining.
31. A method for storing bitstream of a video comprising: determining a first signal (Y) attribute can be predicted from a second signal (X) attribute; generating a bitstream based on the determining; and storing the bitstream in a non-transitory computer-readable recording medium.
32. A method, apparatus or system described in the present disclosure.

In the solutions described herein, an encoder may conform to the format rule by producing a coded representation according to the format rule. In the solutions described herein, a decoder may use the format rule to parse syntax elements in the coded representation with the knowledge of presence and absence of syntax elements according to the format rule to produce decoded video.

In the present disclosure, the term “video processing” may refer to video encoding, video decoding, video compression or video decompression. For example, video compression algorithms may be applied during conversion from pixel representation of a video to a corresponding bitstream representation or vice versa. The bitstream representation of a current video block may, for example, correspond to bits that are either co-located or spread in different places within the bitstream, as is defined by the syntax. For example, a macroblock may be encoded in terms of transformed and coded error residual values and also using bits in headers and other fields in the bitstream. Furthermore, during conversion, a decoder may parse a bitstream with the knowledge that some fields may be present, or absent, based on the determination, as is described in the above solutions. Similarly, an encoder may determine that certain syntax fields are or are not to be included and generate the coded representation accordingly by including or excluding the syntax fields from the coded representation.

The disclosed and other solutions, examples, embodiments, modules and the functional operations described in this disclosure can be implemented in digital electronic circuitry, or in computer software, firmware, or hardware, including the structures disclosed in this disclosure and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., a field-programmable gate array (FPGA) or an application-specific integrated circuit (ASIC).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto optical disks; and compact disc read-only memory (CD ROM) and Digital versatile disc-read only memory (DVD-ROM) disks. The processor and the memory can be supplemented by, or incorporated in, special purpose logic circuitry.

While the present disclosure contains many specifics, these should not be construed as limitations on the scope of any subject matter or of what may be claimed, but rather as descriptions of features that may be specific to particular embodiments of the present disclosure. Certain features that are described in the present disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

Only a few implementations and examples are described and other implementations, enhancements and variations can be made based on what is described and illustrated in the present disclosure.

A first component is directly coupled to a second component when there are no intervening components, except for a line, a trace, or another medium between the first component and the second component. The first component is indirectly coupled to the second component when there are intervening components other than a line, a trace, or another medium between the first component and the second component. The term “coupled” and its variants include both directly coupled and indirectly coupled. The use of the term “about” means a range including ±10% of the subsequent number unless otherwise stated.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, embodiments, systems, subsystems, and methods described and illustrated in the various embodiments as discrete or separate may be combined or integrated with other systems, modules, embodiments, or methods without departing from the scope of the present disclosure. Other items shown or discussed as coupled may be directly connected or may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for processing media data, comprising:
determining at least one prediction model for region-adaptive hierarchical transform (RAHT), wherein in each prediction model, a first coefficient component is predicted from a second coefficient component; and
performing a conversion between a visual media data and a bitstream based on the determining.

2. The method of claim 1, wherein the first coefficient component and the second coefficient component are two different components of an attribute value, or
wherein the first coefficient component and the second coefficient component are from a same attribute value or a same sample, or
wherein the first coefficient component and the second coefficient component are reconstructed values or transformed domain values.

3. The method of claim 1, wherein a linear function or a non-linear function is applied during prediction of the first coefficient component from the second coefficient component, and wherein function parameters of the linear function or the non-linear function are derived, pre-defined, or included in the bitstream.

4. The method of claim 1, wherein the first coefficient component and the second coefficient component are from different attribute values or from different samples, or
wherein the first coefficient component is predicted from neighbors of the second coefficient component in a same or different layer, or
wherein the first coefficient component and the second coefficient component are residue values, transformed residue values, or a combination of residue values and transformed residue values, or
wherein the first coefficient component (Y_{pred}) is predicted from the second coefficient component (X_{rec}) that has been reconstructed, and wherein a prediction model of the at least one prediction model is denoted as:
$${Y}_{pred} = α * {X}_{rec} + β$$
where α and β are parameters of the prediction model.

5. The method of claim 1, wherein an alternating current (AC) component of the first coefficient component is predicted from an AC component of the second coefficient component that has been reconstructed, and wherein a prediction model of the at least one prediction model is denoted as:
$${Y}_{pred , AC} = α * {X}_{rec , AC}$$
where Y_{pred,AC} indicates the AC component of the first coefficient component, X_{rec,AC} indicates the AC component of the second coefficient component, which is a signal obtained by removing a direct current (DC) component from the second coefficient component, and α is a parameter of the prediction model corresponding to X_{rec,AC}.

6. The method of claim 1, wherein the first coefficient component is predicted from second coefficient components of a current sample and of neighboring samples, and wherein a prediction model of the at least one prediction model is denoted as:
$${Y}_{pred} = {α}_{0} * {X}_{rec} + {α}_{1} * {X}_{rec , 1} + … + {α}_{N} * {X}_{rec , N} + β$$
where Y_{pred} indicates the first coefficient component, X_{rec} indicates a second coefficient component of the current sample, X_{rec,i} indicates a second coefficient component of an i^{th} neighboring sample, α₀, α₁ . . . α_{N} and β are parameters of the prediction model, and i and N are integers, or
wherein a number of the neighboring samples is signaled, fixed, or determined based on distance criteria, wherein the distance criteria comprises a distance threshold that is fixed or signaled, and wherein the distance criteria specifies that only neighboring samples within the distance threshold are included in the prediction model, or
wherein the first coefficient component is predicted from the second coefficient component X_{rec} with a prediction model of the at least one prediction model with non-linear terms, and wherein the prediction model with squared reconstruction
$${X}_{rec}^{2}$$
as non-linear term is denoted as:
$${Y}_{pred} = {α}_{0} * {X}_{rec} + {α}_{1} * {X}_{rec}^{2} + β$$
where α₀, α₁ and β are motion parameters of the prediction model, or
wherein the non-linear terms are signalled, or wherein the prediction model is a fixed model with non-linear terms, or
wherein at least one model parameter of each prediction model is signaled in the bitstream, or
wherein the first coefficient component is predicted from second coefficient components of a current sample and of neighboring samples with a polynomial prediction model denoted as:
$${Y}_{pred} = {α}_{0} * {X}_{rec} + {α}_{1} * {X}_{rec , 1} + … + {α}_{N} * {X}_{rec , N} + {α}_{0}^{′} * {X}_{rec}^{2} + β$$
where Y_{pred} indicates the first coefficient component, X_{rec} indicates a second coefficient component of the current sample, X_{rec,i} indicates a second coefficient component of an i^{th} neighboring sample, α₀, α₁ . . . α_{N}, α′₀, and β are parameters of the polynomial prediction model, and i and N are integers.

7. The method of claim 1, wherein at least one model parameter of each prediction model is derived based on samples reconstructed before a current block or sample, or
wherein the at least one prediction model comprises multiple prediction models, and the multiple prediction models are used for cross-component prediction.

8. The method of claim 1, wherein whether one or more prediction models are applied is signaled or a number of prediction models is signaled, or
wherein at least one model parameter of each prediction model is derived based on a least square estimate, or based on an LDL decomposition.

9. The method of claim 1, wherein the at least one prediction model comprises multiple prediction models, and one or more of the multiple prediction models are selected to be applied,
wherein a selection of the one or more of the multiple prediction models is derived by an encoder or by a decoder,
wherein additional flags are signalled to indicate a result of the selection, or
wherein additional flags are signalled to indicate whether the selection is to be enabled.

10. The method of claim 1, wherein model parameters of the at least one prediction model are signaled, or
wherein model parameters of the at least one prediction model are estimated based on least square minimization, or selected from a set of predetermined values, or
wherein model parameters of the at least one prediction model are partially signaled and partially derived, or
wherein model parameters of the at least one prediction model are estimated, and the model parameters that are estimated are quantized and signaled.

11. The method of claim 1, wherein a prediction model of the at least one prediction model is applied during RAHT coding, and a prediction residual of the first coefficient component is coded by RAHT coding.

12. The method of claim 1, wherein a point cloud is divided into blocks of P×Q×R voxels, wherein a prediction model is selectively enabled or disabled for each block, wherein P, Q, and R are signaled or fixed, and wherein for each block that selects the prediction model, model parameters are signaled, are inherited from neighboring voxels, or are predictively coded, or
wherein a point cloud is divided into blocks of N points and a prediction model is selectively enabled or disabled for each block, and wherein parameters N are signaled or fixed, wherein for each block that selects the prediction model, model parameters are signaled, are inherited from neighboring blocks, or are predictively coded, wherein the point cloud is reordered based on Morton code before being divided into the blocks, or the point cloud is used as a single block, or
wherein a point cloud is divided into regions and a prediction model is selectively enabled or disabled for each region, wherein the regions are derived from clustering algorithms, are signaled, or are derived based on coded geometry information, and wherein for each region that selects the prediction model, model parameters are selectively signaled, are inherited from neighboring regions, or are predictively coded.

13. The method of claim 1, wherein the at least one prediction model is applied during RAHT coding for predicting a RAHT node of the first coefficient component from a RAHT node of the second coefficient component that has been reconstructed, or
wherein the at least one prediction model is applied in a sum of attribute space or applied in a transform domain, or
wherein the at least one prediction model is enabled for a subset of RAHT levels, or
wherein the subset is signaled.

14. The method of claim 1, wherein the at least one prediction model is enabled for a first K1 or last K2 levels of RAHT levels, where K1 and K2 are integers, or
wherein the at least one prediction model is enabled for a subset of RAHT levels and the subset is a fixed subset, or
wherein model parameters of the at least one prediction model are derived from neighboring nodes, and wherein the neighboring nodes are used as training samples to derive the model parameters, or
wherein a cost reduction by employing a prediction model is denoted as:
$${Cost}_{reduction} = {Cost}_{pred} - {Cost}_{unpred} ,$$
where Cost_{reduction} is the cost reduction, Cost_{pred} is a prediction cost of neighboring nodes of a RAHT node with enabling the prediction model, Cost_{unpred} is a prediction cost of the neighboring nodes without enabling the prediction model, and wherein the prediction model is applied for the RAHT node only if Cost_{reduction} is less than a threshold, or
wherein model parameters of a prediction model are derived from neighbors only for RAHT nodes included in some regions, or
wherein model parameters of a prediction model are derived and signaled conditionally on an RAHT layer level, an RAHT node level, or an RAHT region level, or
wherein model parameters of a prediction model are predictively coded across RAHT layers, nodes, or regions, or
wherein the at least one prediction model is used in predictive transform attribute coding or is applied only for lossless compression.

15. The method of claim 1, wherein the at least one prediction model is enabled or disabled for different RAHT layers, nodes, or regions based on flag(s) signaled per-layer, per-node, or per-region, respectively.

16. The method of claim 1, wherein the conversion comprises encoding the visual media data into the bitstream.

17. The method of claim 1, wherein the conversion comprises decoding the visual media data from the bitstream.

18. An apparatus for processing media data, comprising: a processor; and a non-transitory memory with instructions thereon, wherein the instructions upon execution by the processor, cause the processor to:
determine at least one prediction model for region-adaptive hierarchical transform (RAHT), wherein in each prediction model, a first coefficient component is predicted from a second coefficient component; and
perform a conversion between a visual media data and a bitstream based on the determination.

19. A non-transitory computer-readable storage medium storing instructions that cause a processor to:
determine at least one prediction model for region-adaptive hierarchical transform (RAHT), wherein in each prediction model, a first coefficient component is predicted from a second coefficient component; and
perform a conversion between a visual media data and a bitstream based on the determination.

20. A non-transitory computer-readable recording medium storing a bitstream of a media data which is generated by a method performed by a media data processing apparatus, wherein the method comprises:
determining at least one prediction model for region-adaptive hierarchical transform (RAHT), wherein in each prediction model, a first coefficient component is predicted from a second coefficient component; and
generating a bitstream based on the determining.
